(19) United States
(12) Patent Application Publication
(10) Pub. No.: US 2003/0052670 A1
(43) Pub. Date: Mar. 20, 2003

(54) Non-invasive detectors for wells

(75) Inventor: Antoni Miszewski, Budleigh Salterton (GB)

Correspondence Address: THE FIRM OF KARL F ROSS, 5676 RIVERDALE AVENUE, PO BOX 900, RIVERDALE (BRONX), NY, 10471-0900, US

(73) Assignee: Antech Limited

(21) Appl. No.: 10/201,503

(22) Filed: Jul. 22, 2002

(30) Foreign Application Priority Data
Sep. 17, 2001 (GB) 0122431.0

(51) Int. Cl. G01N 27/72

(52) U.S. Cl. 324/228; 324/220; 324/221

(57) ABSTRACT

A detector for detecting magnetic field disturbances resulting from the movement of equipment 11 through a pipe 10 of magnetic material. A pair of linear ferrite magnetic elements 22A, 23A are positioned end to end and aligned with the axis of the pipe, and a Hall effect device 21A is positioned between the magnetic elements. The ferrite rods concentrate magnetic field changes due to the equipment 11 through the Hall effect device. Two pairs of elements 22A-23A and 22B-23B are spaced around the pipe, and a second set of pairs of elements 25B-27B, 26B is spaced along the pipe. The detector can be attached to an existing pipe, or mounted in an instrument package which passes through the pipe.

### FIELD OF THE INVENTION

The present invention relates to non-invasive detectors for detecting the presence of pieces of equipment through the walls of a steel pipes, typically, of pipes that are used in oil wells and the like.

### BACKGROUND OF THE INVENTION

In the oil industry, it is common to retain moving equipment inside a pressure vessel. An example is a downhole instrument which is retrieved from a well through a riser. The problem is that the pressure vessel forming the top of the riser is usually made of steel, and this stops the operator of the equipment from seeing what is going on because he cannot see through steel. Accordingly, some sort of sensor is required, so that the equipment operator can detect what is going on inside the pressure vessel without having to open it. This has safety benefits because it may prevent an accident and it has operational benefits because it may allow the operator to position equipment more accurately.

In the context of oil wells, there is a variety of possible pieces of equipment which it is desirable to be able to detect, including:

detecting a wireline tool being pulled into a riser, where pulling too far may risk breaking the cable weak point;

detecting the end of coiled tubing that has broken where the operator does not know the point at which the coil parted;

detecting the launch of a cement plug, to check that it has launched at the intended time during the operation;

detecting the presence of equipment inside a pipeline;

detecting the position of a piece of equipment that is being deployed into a well through a BOP;

detecting the dropping of a ball through pipe; and

detecting the presence of tool joints that are pulled through the blind rams of a BOP stack of a subsea wellhead.

It is known to use detectors which detect magnetic fields. The commonest sensing technique uses sensing coils.

GB 0 943 064 (Shell) provides a drive coil and a pair of sensing coils mounted one to each side of the drive coil around a well head connector; the sensing coils are connected to a difference bridge. A major disadvantage of this system is that the coils encircle the riser. The system therefore has to be original equipment which is installed during the manufacture of the riser; it is not generally feasible to install a coil around an existing riser. Further, the use of coils, particularly drive coils, is undesirable because they may store energy, and in some situations where inflammable material is involved this can be hazardous.

GB 2 105 041 A (Ferranti) shows a clip-on detector for detecting the movement of a pig through a pipe. The pig has a pair of opposed magnets along its axis (or a single magnet). The detector comprises a coil around a magnetic yoke aligned along the pipe and with pole pieces held against the pipe.

GB 1 602 065 (Monitoring Systems) shows several sensors spaced apart down a well head to detect the movement of pipe joints past them. Each sensor comprises a pair of opposed magnets with a coil in the space between them, producing positive or negative pulses depending on the direction of movement of the joints. The sensor drives an up/down counter which counts the number of joints passing it.

U.S. Pat. No. 5,323,856 (Halliburton) detects cementing plugs in a well. The cementing plug has a magnet, preferably longitudinal. The detector comprises a pair of longitudinally spaced pole pieces with a flux gate structure between them.

As an alternative to sensing coils, other sensing devices can be used. Thus Halliburton suggests a variety of detectors, such as the use of Hall effect, fibre optic, or Faraday effect detectors. U.S. Pat. No. 3,843,923 (Stewart & Stevenson) is a more detailed example of the use of Hall effect devices. To detect the movement of a pipe joint through a pipe, a locator comprises a ring magnet with a pair of detector rings mounted one on each side. Each detector ring comprises a set of four Hall effect devices mounted around the pipe. The Hall effect devices of a set have their outputs summed, and the sums of the two sets are differenced.

All these devices depend on the detection of a changing magnetic field, as mentioned above. The magnetic field may be generated by the detection device, as for example in Shell, Monitoring Systems, and Stewart & Stevenson; alternatively, it may be generated by one or more magnets mounted on the body which moves through the pipe or riser, as in Ferranti and Halliburton.

The general object of the present invention is to provide an improved detector suitable for use with oil well pipes and risers.

### BRIEF SUMMARY OF THE INVENTION

According to the invention, there is provided a detector for detecting magnetic field disturbances resulting from the movement of equipment through a pipe of magnetic material, the detector comprising a pair of linear magnetic elements positioned end to end and aligned with the axis of the pipe and a Hall effect device positioned between the magnetic elements. By “magnetic”, we mean a material, such as ferrite, which has a low magnetic resistance and thus gathers magnetic flux through it.

Preferably there is a plurality of detectors spaced around the pipe and/or along the pipe.

The detector can conveniently be in a form which can be attached to an existing pipe.

In an alternative form of detector, the detector is mounted in an instrument package which passes through the pipe. This form of detector detects relative movement of the equipment, ie the instrument package, relative to discontinuities such as joints in the pipe.

The present detector can of course be used in conjunction with a permanent magnet mounted on the equipment to be detected. However, the present detector, in its preferred forms, is capable of achieving sufficient sensitivity for it to be capable of detecting various items of equipment which do not have permanent magnets attached to them. Thus it will often not be necessary for the equipment to have permanent magnets incorporated in it, or for the operator to attach permanent magnets to it. An example is the end of coiled tubing which has broken (taking the term “equipment” in a broad sense here); this is particularly significant because it is obviously impossible for a permanent magnet to be associated with this. A further benefit of a detector which can operate without requiring permanent magnets is that magnets attract ferromagnetic debris which can impair the signal. This situation is particularly prevalent in horizontal wells, because debris collects on the low side of the bore. Equipment which includes a permanent magnet is liable to attract such debris when it is passed through the bore, and the debris can then be carried along with the equipment and give anomalous signals.

### BRIEF DESCRIPTION OF THE SEVERAL VIEWS OF THE DRAWINGS

Two detectors embodying the invention will now be described, by way of example, with reference to the drawings, in which:

FIG. 1 shows the first detector in longitudinal and transverse section;

FIG. 2 shows part of the first detector in more detail; and

FIG. 3 shows the second detector in longitudinal and transverse section.

### DETAILED DESCRIPTION OF THE INVENTION

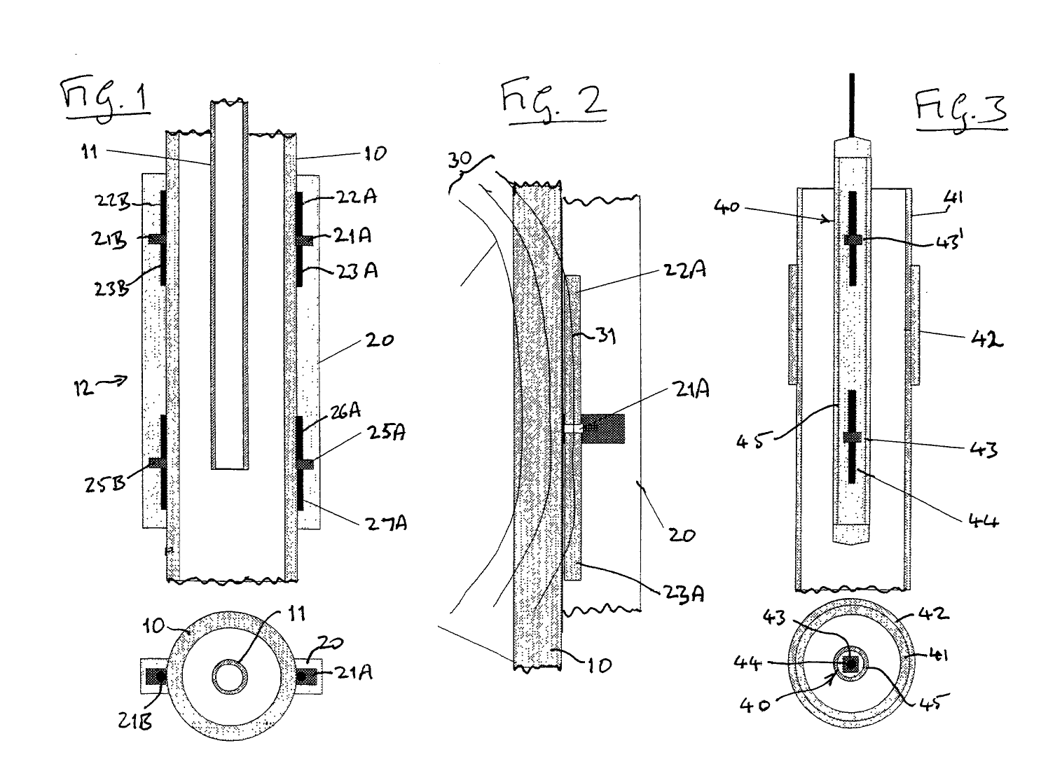

Referring to FIG. 1, the detector 12 is applied to a pipe 10, which is typically of magnetic material such as steel, forming a riser at the head of a well. This pipe is shown as having a tube 11 being lowered through i. The bottom end of the tube 11, which in the situation shown is roughly level with the detector, is the equipment to be detected.

The detector 12 comprises a housing 20 which contains two pairs of sensors, an upper pair and a lower pair. The upper pair of sensors are sensors 21A and 21B, which are diametrically opposite each other around the pipe 10, and shown in the transverse section; the lower pair of sensors 25A and 25B are similarly arranged.

Sensor 21A is also associated with a pair of scavenger rods 22A and 23A; the other sensors have corresponding scavenger rods (22B and 23B for sensor 21B, 26A and 27A for sensor 25A, etc). The scavenger rods are of ferrite, and are held in close contact with the pipe 10. Each rod is of extended linear form; the two rods for a sensor are aligned with the axis of the pipe 10 and are positioned end to end, with the sensor in the gap between them and substantially filling that gap. As shown in FIG. 2, the magnetic flux lines (or more precisely the lines of flux disturbance or variation) 30 from the equipment (the end of the inner pipe 11) tend to be drawn into and longitudinally through the material of the pipe 10. However, the pipe 10 acts as a kind of Faraday cage, preventing the lines of flux from emerging from it. The scavenger rods serve to pull or drag some of the lines of flux 31 outside the body of the outer pipe. This increases the magnetic flux through the sensor 21A, and so results in a stronger signal to be detected.

The present arrangement of sensors allows the signals from the sensors (eg 21A and 25A) that are longitudinally spaced along the pipe to be subtracted from each other in the signal processing. This serves to enhance the response is that detected as the equipment passes through the inside of the pipe. Further, in larger pipe systems, the signals detected by the different sensors with the equipment, ie the inner tube 11, in a different radial position may vary significantly. The present arrangement also allows the signals from all the sensors at the same level around the outer pipe (eg sensors 21A and 21B) to be added together to compensate for this effect.

It may also be desirable for the sensor electronics to incorporate a threshold level setting. This can be used as a comparator signal to give a warning when a change in signal level is detected. Also, by having a threshold level that can be adjusted, it is possible to avoid detections that may be result from sensor or system noise.

The present sensor thus detects, with high efficiency, the magnetic field changes that occur when equipment moves inside the pressure vessel. In some cases it may be possible to put a magnetic marker of the enclosed equipment. In other cases, detection may have to be achieved using the residual magnetic field of the enclosed equipment. The technique can tolerate significant background magnetic fields that can occur on large metal structures such as oil rigs.

The detector can simply be clamped to an existing pipe, with no special installation being required; it is thus cheap and easy to operate. The detector will operate in a high and slowly varying ambient magnetic field, with the circuitry fed by the detector automatically zeroing itself; it is therefore suitable for use on oilrigs and on the seabed where it is difficult to adjust. Further, no added magnets are required either internally or externally, so it can detect unpredicted events such as a broken pipe; again, it is suitable for conditions where minimum operator intervention is desirable or necessary.

Just as a detector can be used to look in to a pipe or tube, a suitable design of detector can also be used to look from the inside to the outside. An example of this would be to use the detector inside a pressure housing as a downhole tool. This could be used to detect anomalies in the pipe around the tool, such as those which occur at a pipe joint.

FIG. 3 shows a second embodiment which achieves this. The detector is housed in a instrument package 40, which is being lowered through an outer pipe or tube 41 which includes a pipe joint 42. The detector has two sensors 43 and 43′ which are axially (longitudinally) separated (like sensors 21A and 25A) and contained within a housing 45. Sensor 43 is positioned between two scavenger rods 44 and 45 aligned longitudinally end to end. These scavenger rods assist in drawing the magnetic field produced by the pipe joint 42 into the interior of the casing 45 for detection by the sensor 43. The other sensor is similarly positioned between two scavenger rods.

1 A detector for detecting magnetic field disturbances resulting from the movement of equipment through a pipe of magnetic material, the detector comprising a pair of linear magnetic elements positioned end to end and aligned with the axis of the pipe and a Hall effect device positioned between the magnetic elements.

2 A detector according to claim 1 wherein the magnetic elements are ferrite.

3 A detector according to claim 1 wherein there is a plurality of pairs of linear magnetic elements, each with its associated Hall effect device, spaced around the pipe.

4 A detector according to claim 1 wherein there is a further set of pairs of linear magnetic elements, each with its associated Hall effect device, spaced along the pipe.

5 A detector according to claim 1 in a form which can be attached to an existing pipe.

6 A detector according to claim 1 mounted in an instrument package which passes through the pipe.
